(19) United States
(12) Patent Application Publication
(10) Pub. No.: US 2016/0236537 A1
(43) Pub. Date: Aug. 18, 2016

(54) SYSTEM AND METHOD OF CONTROLLING VENTILATION OF A PASSENGER COMPARTMENT OF A VEHICLE

(71) Applicant: Ford Global Technologies, LLC, Dearborn, MI (US)

(72) Inventors: Clay Wesley Maranville, Ypsilanti, MI (US); Paul Bryan Hoke, Plymouth, MI (US)

(21) Appl. No.: 15/137,625

(22) Filed: Apr. 25, 2016

Related U.S. Application Data
(62) Division of application No. 13/537,712, filed on Jun. 29, 2012, now abandoned.

(51) Int. Cl. B60H 1/00; B60H 1/26

(52) U.S. Cl. CPC B60H 1/00785; B60H 1/26; B60H 1/00735; B60H 1/00842

(57) ABSTRACT

A system and method of controlling ventilation of a passenger compartment of a vehicle. An intake vent may be opened to allow ambient air to enter the passenger compartment and an exhaust vent may be opened to allow cabin air to exit the passenger compartment when the cabin air temperature is greater than the adjusted ambient air temperature value and a precipitation condition is not present.

### CROSS-REFERENCE TO RELATED APPLICATION

This application is a divisional of U.S. application Ser. No. 13/537,712, filed Jun. 29, 2012, the disclosure of which is hereby incorporated in its entirety by reference herein.

### TECHNICAL FIELD

The present application relates to a system and method of controlling ventilation of a passenger compartment of a vehicle.

### BACKGROUND

An installation for ventilating a passenger compartment of a vehicle is disclosed in U.S. Pat. No. 6,497,275.

### SUMMARY

In at least one embodiment, a method of controlling ventilation of a vehicle passenger compartment is provided. The method may include determining a cabin air temperature, determining an adjusted ambient air temperature value, and determining whether a precipitation condition is present. An intake vent may be opened to allow ambient air to enter the passenger compartment and an exhaust vent may be opened to allow cabin air to exit the passenger compartment when the cabin air temperature is greater than the adjusted ambient air temperature value and a precipitation condition is not present.

In at least one embodiment, a method of controlling ventilation of a passenger compartment of a vehicle is provided. The method may include determining whether a key off condition is present. A cabin air temperature may be compared to an adjusted ambient air temperature value when the key off condition is present. A determination may be made whether a precipitation condition is present and whether air humidity is less than a threshold humidity level. An intake vent may be opened to allow ambient air from outside the vehicle to enter the passenger compartment through an intake passage when the cabin air temperature is greater than the adjusted ambient air temperature value, a precipitation condition is not present, and the air humidity is less than a threshold humidity value.

In at least one embodiment, a system for ventilating a passenger compartment of a vehicle is provided. The system may include an air intake, an air exhaust, an ambient air temperature sensor, a cabin air temperature sensor, a key sensor, and an air humidity sensor. The air intake may provide ambient air to the passenger compartment. The air intake may have an intake vent and an intake vent actuator for moving the intake vent between an open position and a closed position. The air exhaust may exhaust cabin air from the passenger compartment to outside the vehicle. The air exhaust may have an exhaust vent and an exhaust vent actuator for moving the exhaust vent between an open position and a closed position. The ambient air temperature sensor may provide data indicative of a temperature of ambient air outside the passenger compartment. The cabin air temperature sensor may provide data indicative of a temperature of cabin air inside the passenger compartment. The key sensor may determine whether a key off condition is present. The air humidity sensor may provide data indicative of air humidity. The intake vent actuator may move the intake vent to the open position and the exhaust vent actuator may move the exhaust vent to the open position when the key off condition is present, the temperature of cabin air exceeds the temperature of ambient air by a predetermined threshold temperature amount, and the air humidity is less than a threshold humidity level.

### BRIEF DESCRIPTION OF THE DRAWINGS

FIG. 1 is a representation of an exemplary vehicle having a passenger compartment.

FIG. 2 is a flowchart of an exemplary method of controlling ventilation of the passenger compartment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

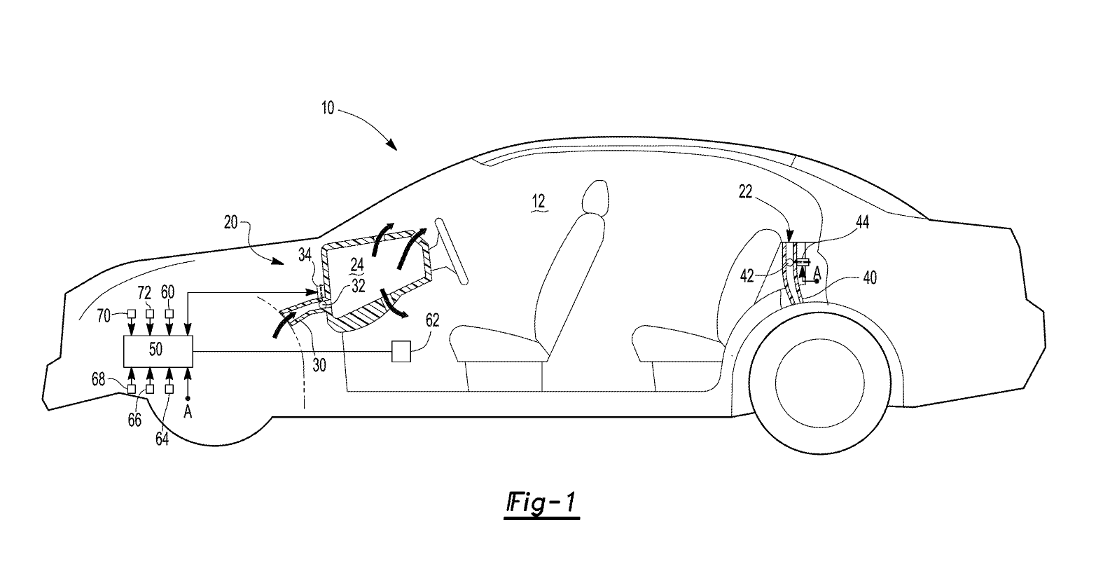

Referring to FIG. 1, a schematic representation of a vehicle 10 is shown. The vehicle 10 may be of any suitable type, such as a motor vehicle like a car or truck.

The vehicle 10 may include a cabin or passenger compartment 12. The passenger compartment 12 may be disposed inside the body of the vehicle 10 and may be configured to receive a vehicle occupant. The vehicle 10 may also include an air intake 20 and an air exhaust 22 that fluidly connect the passenger compartment 12 to ambient air outside the vehicle 10. A heating, ventilation, and air conditioning (HVAC) system 24, which may also be called a climate control system, may be located in the passenger compartment 12, such as under an instrument panel. The HVAC system 24 may be provided to actively circulate, heat and/or cool air in the passenger compartment 12.

Ambient air or air from outside the vehicle 10 may be provided to the passenger compartment 12 via the air intake 20. The air intake 20 may include an intake passage 30, such as a duct or opening, through which ambient air passes to enter the vehicle 10 and the passenger compartment 12. The inlet of the intake passage 30 may be located in any suitable location, such as near a wheel well or under the vehicle. In such locations, the ambient air may be cooler than at other locations, such as near the cowl. In at least one embodiment, the air intake 20 may be configured to provide ambient air to the passenger compartment 12 without passing through the HVAC system 24. Bypassing the HVAC system 24 may result in reduced airflow restriction and increase airflow volumes. Alternatively or in addition, the air intake 20 may provide air to the HVAC system 24 in one or more embodiments.

The air intake 20 may also include an intake vent 32 and an intake vent actuator 34. The intake vent 32 may be configured to control the flow of air through the intake passage 30. The intake vent 32 may be disposed in the intake passage 30 and may have any suitable configuration. For example, the intake vent 32 may be configured as one or more doors or louvers. In an embodiment having a plurality of doors or louvers, the doors or louvers may be interconnected with a linkage or control shaft that may permit multiple doors or louvers to be actuated simultaneously by the intake vent actuator 34. The intake vent 32 may move between an open position and a closed position. In the open position, ambient air may flow through the intake passage 30 from outside the vehicle 10 into the passenger compartment 12. In the closed position, ambient air may be inhibited from flowing through the intake passage 30 from outside the vehicle 10 into the passenger compartment 12.

The intake vent actuator 34 may actuate or move the intake vent 32 between the open and closed positions. The intake vent actuator 34 may be of any suitable type, such as an electrical, mechanical, electromechanical, or pneumatic actuator or combinations thereof. For example, the intake vent actuator 34 may be a motor, solenoid, spring, or shape-memory alloy.

Air inside the passenger compartment 12 or cabin air may be exhausted from the passenger compartment 12 to outside the vehicle 10 via the air exhaust 22. The air exhaust 22 may include an exhaust passage 40, such as a duct or opening, through which cabin air passes to exit the vehicle 10. The inlet of the exhaust passage 40 may be located in any suitable location, such as in the passenger compartment 12 or trunk of the vehicle 10. In embodiments in which the exhaust passage 40 is disposed in the trunk of a vehicle 10, an opening may be provided to fluidly connect the passenger compartment 12 to the trunk.

The air exhaust 22 may also include an exhaust vent 42 and an exhaust vent actuator 44. The exhaust vent 42 may be configured to control the flow of air through the exhaust passage 40. The exhaust vent 42 may be disposed in the exhaust passage 40 and may have any suitable configuration. For example, the exhaust vent 42 may be configured as one or more doors or louvers. In an embodiment having a plurality of doors or louvers, the doors or louvers may be interconnected with a linkage or control shaft that may permit multiple doors or louvers to be actuated simultaneously by the exhaust vent actuator 44. The exhaust vent 42 may move between an open position and a closed position. In the open position, ambient air may flow through the exhaust passage 40 from the passenger compartment 12 to the surrounding environment outside the vehicle 10. In the closed position, ambient air may be inhibited from flowing through the exhaust passage 40 from the passenger compartment 12 out of the vehicle 10.

The exhaust vent actuator 44 may actuate or move the exhaust vent 42 between the open and closed positions. The exhaust vent actuator 44 may be of any suitable type, such as an electrical, mechanical, electromechanical, or pneumatic actuator or combinations thereof. For example, the exhaust vent actuator 44 may be a motor, solenoid, spring, or shape-memory alloy.

At least one controller or control module 50 may be provided to monitor and/or control the operation of various components and subsystems of the vehicle 10. For example, the control module 50 may monitor and/or control operation of the intake vent actuator 34 to control positioning of the intake vent 32. Similarly, the control module 50 may monitor and/or control operation of the exhaust vent actuator 44 to control positioning the exhaust vent 42. The connection or communication between the control module 50 and exhaust vent actuator 44 is represented by connection node A in FIG. 1.

The control module 50 may receive signals from one or more sensors or input devices, such as an ambient air temperature sensor 60, a cabin air temperature sensor 62, an air humidity sensor 64, a sunload sensor 66, a precipitation sensor 68, a battery state of charge sensor 70, and a key sensor 72. In addition, one or more of these sensors may be a virtual sensor that may be based on or supplemented by data provided to the vehicle 10 from an external source, such as data transmitted to or received by vehicle telematics system or data from a mobile phone as will be discussed in more detail below.

The ambient air temperature sensor 60 may provide a signal or data indicative of the temperature of ambient air outside the vehicle 10. In at least one embodiment, the ambient air temperature sensor 60 may be a physical sensor that is disposed on the vehicle 10 that detects ambient air temperature. Such a sensor may be of any suitable type, such as a thermocouple or thermistor. The ambient air temperature sensor 60 may also be a virtual sensor that may not be a physical sensor that is disposed on the vehicle 10. For instance, a signal or data indicative of the actual or predicted temperature of ambient air outside the vehicle 10, such as from recent weather observation data, may be wirelessly transmitted to the vehicle 10 or to a vehicle telematics system from an external or non-vehicular source. Such data may be based on the location of the vehicle 10 as may be determined with a positioning system and may be provided from a data feed or web site and may be transmitted in conjunction with a mobile phone in one or more embodiments.

The cabin air temperature sensor 62 may provide a signal or data indicative of the temperature of ambient air inside the passenger compartment 12. In at least one embodiment, the cabin air temperature sensor 62 may be a sensor that is disposed in the passenger compartment 12 that detects air temperature. Such a sensor may be of any suitable type, such as a thermocouple or thermistor.

The air humidity sensor 64 may provide a signal or data indicative of the humidity of air, such as the humidity of ambient air and/or the cabin air. In at least one embodiment, the air humidity sensor 64 may be a physical sensor that is disposed on the vehicle 10 that detects the humidity of ambient air outside the passenger compartment 12 or the humidity of cabin air in the passenger compartment 12. Such a sensor may be of any suitable type, such as a capacitive, resistive, or thermal conductivity humidity sensor. The air humidity sensor 64 may also be a virtual sensor that may not be a physical sensor that is disposed on the vehicle 10. For instance, a signal or data indicative of the actual or predicted humidity of ambient air outside the vehicle 10, such as from recent weather observation data, may be wirelessly transmitted to the vehicle 10 or to a vehicle telematics system from an external or non-vehicular source. Such data may be based on the location of the vehicle 10 as may be determined with a positioning system and may be provided from a data feed or web site and may be transmitted in conjunction with a mobile phone in one or more embodiments.

The sunload sensor 66 may provide a signal or data indicative of solar energy proximate the vehicle 10. In at least one embodiment, the sunload sensor 66 may be a physical sensor that is disposed on the vehicle 10 that detects the intensity and/or directionality of solar radiation that may penetrate and heat air in the passenger compartment 12. Such a sensor may be of any suitable type. The sunload sensor 66 may also be a virtual sensor that may not be a physical sensor that is disposed on the vehicle 10. For instance, a signal or data indicative of the actual or predicted sunload or sunlight conditions, such as from recent weather observation data, may be wirelessly transmitted to the vehicle 10 or to a vehicle telematics system from an external or non-vehicular source. Such data may be based on the location of the vehicle 10 as may be determined with a positioning system and may be provided from a data feed or web site and may be transmitted in conjunction with a mobile phone in one or more embodiments. In addition, data from the sunload sensor 66 may be used to supplement or in place of data from the precipitation sensor 68 since precipitation may not be positively correlated with elevated sunload conditions (e.g., precipitation is less likely to be present in sunny conditions).

The precipitation sensor 68 may provide a signal or data indicative of precipitation proximate the vehicle 10. In at least one embodiment, the precipitation sensor 68 may be a physical sensor that is disposed on the vehicle 10 that detects the intensity or presence of precipitation, such as rain, proximate the vehicle 10. Such a sensor may be of any suitable type. The precipitation sensor 68 may also be a virtual sensor that may not be a physical sensor that is disposed on the vehicle 10. For instance, a signal or data indicative of the actual or predicted precipitation conditions, such as from recent weather observation data, may be wirelessly transmitted to the vehicle 10 or to a vehicle telematics system from an external or non-vehicular source. Such data may be based on the location of the vehicle 10 as may be determined with a positioning system and may be provided from a data feed or web site and may be transmitted in conjunction with a mobile phone in one or more embodiments.

The battery state of charge sensor 70 may provide a signal or data indicative of the state of electrical charge of a battery that may be provided with the vehicle 10. In at least one embodiment, the battery state of charge sensor 70 may be a physical sensor that is disposed on the vehicle 10 and may detect voltage that may be available from the battery.

The key sensor 72 may provide a signal or data indicative of the operational state of the vehicle 10 or commands indicative of a request to change the operational state. For example, the key sensor 72 may detect whether the vehicle is off (key off), on (key on or remote start requested) or in an accessory mode that may be selected by a vehicle operator in which the engine or ignition is off but power is provided to some vehicle functions. The key sensor 72 may also detect or receive signals from a key fob that are indicative of user commands, such as commands that are wirelessly transmitted from a key fob to the vehicle 10 to start the engine, unlock vehicle doors, or open vehicle doors or windows.

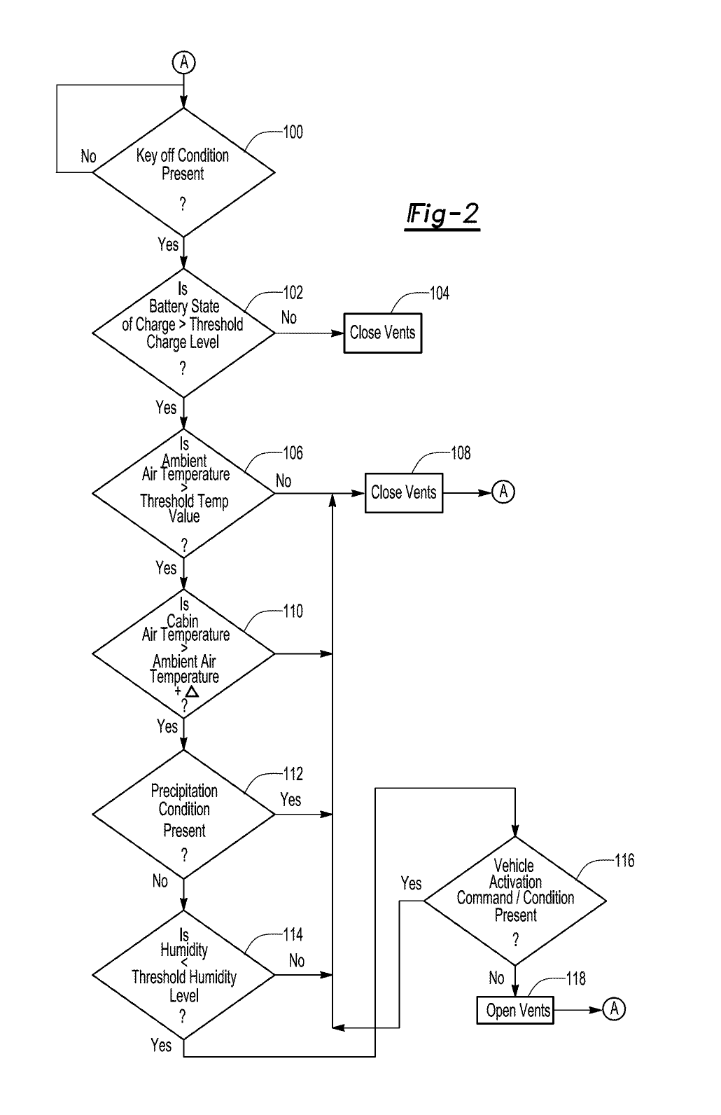

Referring to FIG. 2, a flowchart of an exemplary method of control of ventilation of a passenger compartment 12 of the vehicle 10 is shown. As will be appreciated by one of ordinary skill in the art, the flowchart represents control logic which may be implemented or affected in hardware, software, or a combination of hardware and software. For example, the various functions may be affected by a programmed microprocessor. The control logic may be implemented using any of a number of known programming and processing techniques or strategies and is not limited to the order or sequence illustrated. For instance, interrupt or event-driven processing may be employed in real-time control applications rather than a purely sequential strategy as illustrated. Likewise, parallel processing, multitasking, or multi-threaded systems and methods may be used. In at least one embodiment, the method may be executed and may be implemented as a closed loop control system.

Control logic may be independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the method of control. The illustrated functions may be modified, or in some cases omitted, without departing from the spirit or scope intended.

At 100, the method may determine whether a key off condition is present. Determination of whether a key off condition is present may be based on a signal or data from the key sensor 72 and may be indicative that the vehicle engine is not running or in an accessory mode and/or that the vehicle 10 is not in motion. If a key off condition is not present, then the method may return to block 100 to periodically reassess whether a key off condition is present. If a key off condition is present, the method may continue at block 102.

At 102, the battery state of charge may be assessed. The battery state of charge may be assessed to determine whether there is sufficient power to execute additional method steps without impairing other vehicle functions, such as future starting of the vehicle 10. The battery state of charge may be based on a signal or data from the battery state of charge sensor 70 and may be compared to a predetermined threshold charge level. If the battery state of charge is less than the threshold charge level, then the method may continue at block 104 where the intake vent 32 and/or exhaust vent 42 may be closed by actuating the intake vent actuator 34 and exhaust vent actuator 44, respectively. As such, precipitation may be inhibited from entering the passenger compartment 12 via the intake and/or exhaust passages 30, 40, respectively. If the battery state of charge is not less than the threshold charge level, then the method may continue at block 106.

At 106, the ambient air temperature may be assessed. The ambient air temperature may be the temperature of ambient air outside the vehicle 10, which may be based on or provided by the ambient air temperature sensor 60. The ambient air temperature may be compared to a predetermined or threshold temperature value. If the ambient air temperature is not greater than the threshold temperature value, then the method may continue at block 108 where the intake vent 32 and/or exhaust vent 42 may be closed by actuating the intake vent actuator 34 and exhaust vent actuator 44, respectively, to inhibit precipitation from entering the passenger compartment 12 via the intake and/or exhaust passages 30, 40, respectively. If the ambient air temperature value is greater than the threshold temperature value, then the method may continue at block 110.

At 110, the cabin air temperature or temperature of air in the passenger compartment 12 may be assessed. The cabin air temperature may be based on a signal or data from the cabin air temperature sensor 62. The cabin air temperature may be compared to an adjusted ambient air temperature value in accordance with formula 1.

T_{cabin}>T_{adjusted} (1)

where:
T_{cabin} is the temperature of air in the passenger compartment; and
T_{adjusted} is an adjusted ambient air temperature value.

The adjusted ambient air temperature value may be based in part on the temperature of ambient air outside the vehicle 10, which may be based on or provided by the ambient air temperature sensor 60, and a predetermined threshold temperature amount or value in accordance with formula 2.

T_{adjusted}=T_{ambient}+Δ (2)

where:
T_{ambient} is the temperature of ambient air outside the vehicle; and
Δ is a predetermined threshold temperature amount.

The predetermined threshold temperature amount or value (Δ) may be a constant or may be a variable amount that may be based on vehicle development testing. For example, the predetermined threshold temperature amount may be selected from a set of values in a lookup table and may be based on the ambient air temperature. In at least one exemplary embodiment, predetermined threshold temperature values or amounts may decrease as ambient temperature increases, which may result in earlier opening of the intake and exhaust vents 32, 42 to help reduce cabin air temperature. As an example, predetermined threshold temperature amounts (Δ) may be in the range of approximately 2 to 20° C. in one or more embodiments.

If the cabin air temperature is not greater than the adjusted ambient air temperature, then the method may return to block 108 to monitor and reassess the cabin air temperature or any previous block. If the cabin air temperature is greater than the adjusted ambient air temperature, then the method may continue at block 112.

At 112, the method may determine whether a precipitation condition in present. Determination of whether a precipitation condition is present may be based on a signal or data from the precipitation sensor 68 and/or the sunload sensor 66 as previously discussed. If a precipitation condition is present, then the method may continue at block 108. If a precipitation condition is not present, then the method may continue at block 114.

At 114, the air humidity level may be assessed. The air humidity level may be based on a signal or data from the air humidity sensor 64 and may be indicative of the humidity of air in the ambient air and/or the cabin air. The air humidity level may be compared to a predetermined threshold humidity level. The threshold humidity level may be a constant or may be a variable amount that may be based on vehicle development testing. For example, the predetermined threshold humidity level may be selected from a set of values in a lookup table and may be based on the ambient air temperature. In at least one exemplary embodiment, predetermined threshold humidity values may decrease as ambient temperature increases to prevent more humid ambient air from being allowed into the passenger compartment 12. If the air humidity level is not less than the predetermined threshold humidity level, then the method continues at block 108. If the air humidity level is less than the threshold humidity level, then the method may continue at block 116.

At 116, a determination may be made as to whether a vehicle activation command or condition is present. Determination of whether a vehicle activation command or condition is present may be based on a signal or data from the key sensor 72. Vehicle activation commands may include a command to unlock or open vehicle doors, open a vehicle window, or to start the vehicle 10 or vehicle engine. If a vehicle activation command is not detected, then the method may continue at block 118. If a vehicle activation command is detected, then the method may continue at block 108 where the intake vent 32 and/or exhaust vent 42 may be closed.

At 118, the intake vent 32 and/or exhaust vent 42 may be opened to permit external ambient air to enter the passenger compartment 12 and to permit cabin air to exit the passenger compartment 12 via the intake and/or exhaust passages 30, 40, respectively. The intake vent 32 and/or exhaust vent 42 may be opened by actuating the intake vent actuator 34 and/or exhaust vent actuator 44, respectively.

The system and method described in the present application may help ventilate cabin air under appropriate conditions to improve occupant time to comfort. More specifically, the passenger compartment 12 may contain a volume of air that may be heated by solar energy that passes through vehicle windows or heats vehicle surfaces. Solar energy may increase the temperature of uncirculated cabin air that is trapped in the passenger compartment 12 and create hot surfaces in the passenger compartment 12. Increased cabin air temperatures and hot surfaces may decrease passenger comfort and increase the amount of time and energy needed for the HVAC system 24 to cool the passenger compartment 12 to a desired temperature or comfort level. By circulating cabin air in the manner described above, cooler air may be provided to the passenger compartment 12 and hotter air may be exhausted from the passenger compartment 12 without activating an air conditioning system and with low energy consumption. Moreover, intelligent air intake and exhaust control may inhibit water ingression due to precipitation and avoid the intake of comparatively high humidity air into the passenger compartment 12 that may reduce occupant comfort.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-7. (canceled)

8. A method comprising:
in response to cabin temperature exceeding a threshold temperature, an absence of a precipitation condition, and humidity being less than a threshold humidity, opening an intake vent located under a vehicle and an air exhaust inlet located in a cabin of the vehicle to prompt circulation of air through the vehicle due to differences in air temperature under the vehicle and in the cabin without operating a climate system.

9. (canceled)

10. The method of claim 9 further comprising, in response to presence of a precipitation condition, closing the intake vent and air exhaust inlet.

11. The method of claim 9 further comprising, in response to the humidity exceeding the threshold humidity, closing the intake vent and air exhaust inlet.

12. (canceled)

13. The method of claim 9 further comprising, in response to the cabin temperature falling below the threshold temperature, closing the intake vent and air exhaust inlet.

14-20. (canceled)

21. A method comprising:
in response to cabin temperature exceeding a threshold temperature, an absence of a precipitation condition, and humidity being less than a threshold humidity, opening a wheel well intake vent of a vehicle and an air exhaust inlet located in a cabin of the vehicle to prompt circulation of air through the vehicle due to differences in air temperature at the intake and in the cabin without operating a climate system.

22. The method of claim 21 further comprising, in response to presence of a precipitation condition, closing the intake vent and air exhaust inlet.

23. The method of claim 21 further comprising, in response to the humidity exceeding the threshold humidity, closing the intake vent and air exhaust inlet.

24. The method of claim 21 further comprising, in response to the cabin temperature falling below the threshold temperature, closing the intake vent and air exhaust inlet.
